(19) United States
(12) Patent Application Publication
(10) Pub. No.: US 2025/0005505 A1
(43) Pub. Date: Jan. 2, 2025

(54) SERVER FOR PROVIDING E-COMMERCE PLATFORM SERVICE THAT SPONSORS PRODUCTS TO CONTENT CREATOR AND METHOD OF OPERATING SERVER

(71) Applicant: CONIALAB CO., LTD., Seoul (KR)

(72) Inventor: HYUN JUNG NA, Gyeonggi-do (KR)

(21) Appl. No.: 18/755,126

(22) Filed: Jun. 26, 2024

(30) Foreign Application Priority Data
Jun. 27, 2023 (KR) 10-2023-0082745

(51) Int. Cl. G06Q 10/0835; G06Q 30/0601

(52) U.S. Cl. CPC G06Q 10/0835; G06Q 30/0613

(57) ABSTRACT

A platform server includes a communication device, a memory configured to store one or more instructions, and a processor configured to execute the one or more instructions stored in the memory, and the processor executes the one or more instructions to determine at least one content creator to receive sponsorship for a supply product from a supplier among a plurality of content creators, provide content for the supply product that is created by the at least one content creator to at least one seller selling the supply product, and distribute a specified proportion of sales money of the sold product to the at least one content creator when the supply product is sold through the online shop of the at least one seller.

### CROSS REFERENCE TO RELATED APPLICATIONS AND CLAIM OF PRIORITY

This application claims the benefit under 35 USC § 119 of Korean Patent Application No. 10-2023-0082745 filed on Jun. 27, 2023 in the Korean Intellectual Property Office, the entire disclosure of which is incorporated herein by reference for all purposes.

### BACKGROUND

### 1. Field

Embodiments disclosed herein relate to a platform service technology for providing an e-commerce environment.

### 2. Description of Related Art

With the development of information and communication technology, online commerce, that is, e-commerce, which involves selling products by establishing an online market, has developed. The initial form of online commerce is that sellers directly open their own online shopping malls and register products and visitors who access the online shopping malls purchase the products, but, intermediate shopping malls that connect sellers and purchasers have emerged and provided convenient sales and purchasing services, growing into large shopping malls (e.g., Auction, 11th Street, G Market, or the like), and thus causing explosive growth in the e-commerce market. Since then, as various forms of e-commerce emerge in which social commerce using social networks (e.g., Timon, WeMakePrice) and innovative offline distribution and logistics services (e.g., Coupang) are combined, the explosive growth continues. The large-scale e-commerce platforms (e.g., large relay platforms, social commerce, or the like) are bringing a great profit to users, especially sellers.

Nowadays, a new type of e-commerce market using channels of individuals (e.g., influencers, celebrities, or the like) with great influence in social network services (SNSs) (e.g., Facebook, Instagram) and one-person media services (e.g., YouTube, TikTok) or using a strong personal network of a community of people with similar personal interests is being actively formed.

### SUMMARY

However, even if a seller sells a product using a large-scale e-commerce platform described above, the seller has to cover initial costs for marketing to sell the product (e.g., creating a product description page, advertising, or the like) and distributing the product. Furthermore, since the main source of income for the large-scale platforms is fees received from users, high fees may be charged to users, especially sellers, depending on the size of the platform. In addition, competition for the lowest price with multiple sellers within the platform may lower the seller' margin rate, which may lead to a decrease in product quality, causing damage to purchasers and, by extension, a platform service. Even if a platform operator and a small number of sellers get a great profit in the process, the concentrated profit structure may stagnate or deteriorate the development of the platform ecosystem. Further, large-scale e-commerce platforms that focus on relaying product sales may have limitations that make it difficult to engage key members (e.g., influencers, communities, and the like) of the newly formed e-commerce market as new users through social network services (SNSs) and communities.

In addition, in existing platform services, the user has to personally find a creator to request the creation of content to promote a product, and even if a creator is found, in many cases, it costs a lot of money to request the content itself, or it is difficult to pay the cost based on sales, and thus, the reality is that there are limitations in producing content with high promotional effectiveness, especially for companies with small business scale. In addition, when a content creator is not famous, it may be difficult for the content creator to receive requests to create content, and thus in many cases, the content creator creates content for an unreasonable reward. In addition, the created content is used in a uniform manner, such as being attached to product descriptions, so it may be difficult to evaluate the promotional effect of the content.

Accordingly, various embodiments of the present invention are directed to providing an e-commerce platform service capable of connecting a user who wishes to request the creation of promotional content for a product to a creator, promoting product sales by using the created content in various ways, and evaluating a contribution of a participant to the product sales and providing an appropriate reward.

In one general aspect, there is provided a platform server including a communication device, a memory configured to store one or more instructions, and a processor configured to execute the one or more instructions stored in the memory, and the processor executes the one or more instructions to determine at least one content creator to receive sponsorship for a supply product from a supplier among a plurality of content creators based on history information about content previously, provide content for the supply product that is created by the at least one content creator to at least one seller selling the supply product, and distribute a specified proportion of sales money of the sold product to the at least one content creator when the supply product is sold through the online shop of the at least one seller.

In addition, the processor may execute the one or more instructions to determine at least one content creator to receive sponsorship for the supply product based on history information about content previously created by content creators.

In addition, the processor may execute the one or more instructions to determine a content creator who has a history of creating content for a product included in the same category as the supply product to be sponsored as at least one content creator to receive sponsorship for the supply product.

In addition, the processor may execute the one or more instructions to determine ranking of the plurality of content creators and determine a content creator within a specified ranking as at least one content creator to receive sponsorship for the supply product.

In addition, the processor may execute the one or more instructions to determine the ranking of the plurality of content creators based on at least one of the number of times previously created content is used in the online shop of the seller and a sales amount of the used product.

In addition, the processor may execute the one or more instructions so that new content creators creating a specified number of content items or less are included in the specified ranking at a specified proportion among the plurality of content creators.

In addition, the processor may execute the one or more instructions to receive sponsorship condition information for the supply product from the supplier terminal, provide the sponsorship condition information to the at least one content creator, request the supplier to sponsor the supply product to the at least one content creator upon receiving a user input accepting a sponsorship condition from a content creator terminal, request the at least one content creator to create content for the sponsored supply product, and provide, to the at least one seller, content for the sponsored supply product that is created in response to the request to create content.

In addition, the content created in response to the request to create content may be received from the content creator terminal, the received content may be registered in the content DB, and the registered content may be uploaded to a sales page of the online shop of the at least one seller upon receiving a request to provide the registered content from a seller terminal.

In addition, the sponsorship condition information may include information on whether the sponsorship product is provided free of charge and information on a numerical value required to distribute sales money.

In addition, the processor may execute the one or more instructions to determine the specified proportion according to a contribution of the at least one content creator to sales of the supply product.

In addition, the processor may execute the one or more instructions to determine the contribution of the at least one content creator based on sales amounts of a plurality of sellers selling the supply product.

In addition, the processor may execute the one or more instructions to determine the contribution of the at least one content creator based on an access route to the online shop where the supply product has been sold.

In addition, the created content may be provided to a purchaser through a space in which the at least one content creator is identifiable, and a specified weight may be assigned to the contribution of the at least one content creator when the purchaser accesses the online shop where the supply product is sold through the content of the space.

In addition, the processor may execute the one or more instructions to register at least one supply product including the supply product of at least one supplier including the supplier in a supply product DB, register a plurality of sellers including the at least one seller with a hierarchy including an upper seller and at least one sub seller subordinate to the upper seller in the seller DB, register at least one sale product of a top seller in a sale product DB, the at least one sale product being at least one of the supply products registered in the supply product DB, create an online shop for each of the plurality of sellers, the online shop including at least one of registered sale products of a top seller to whom the plurality of sellers are subordinate, registering the plurality of content creators in a content creator DB, register content created by the plurality of content creators in a content DB, and upload the registered content to the online shop of the at least one seller upon receiving a request to provide the registered content from a seller terminal.

In addition, the processor may execute the one or more instructions to determine the specified proportion according to a contribution of the at least one content creator to sales of the supply product and determine the contribution of the at least one content creator based on a sales amount of the sub seller in the hierarchy.

In another general aspect, there is provided a method of providing an e-commerce platform service including determining at least one content creator to receive sponsorship for a supply product from a supplier among a plurality of content creators, providing content for the supply product that is created by the at least one content creator to at least one seller selling the supply product, and distributing a specified proportion of sales money of the sold product to the at least one content creator when the supply product is sold through an online shop of the at least one seller.

In still another general aspect, there is provided a computer program including an instruction for determining at least one content creator to receive sponsorship for a supply product from a supplier among a plurality of content creators, an instruction for providing content for the supply product that is created by the at least one content creator to at least one seller selling the supply product, and an instruction for distributing a specified proportion of sales money of the sold product to the at least one content creator when the supply product is sold through an online shop of the at least one seller.

According to an embodiment disclosed herein, an e-commerce platform service provided through a platform server can allow suppliers, sellers, and content creators for distributing and selling products to gather in one platform service, thereby easily finding experts outside their respective own areas and cooperating with each other to sell products. In addition, the e-commerce platform service can reduce risks that users who cooperate in selling products have to bear when selling products on their own, allow the users to do their best by focusing on their areas of expertise, and further promote product sales by distributing sales profit according to a proportion of the contribution of the product sales, thereby creating a virtuous cycle structure in which each entity's profit increases and each entity develops in their own area. In addition, this virtuous cycle structure of the e-commerce platform service can form a healthy market that prevents damage to suppliers and sellers due to competition at the lowest price in existing open markets and provides high-quality products to purchasers at reasonable prices.

In addition, the e-commerce platform service of the platform server does not simply provide a space for users to gather, but also uses a content DB registered on a platform to connect users who need content creation to content creators suitable for the content creation through product sponsorship, thereby making it possible to create content with high promotional effectiveness and provide the created content to platform users through various routes, including content sharing services, so that product sales can be promoted. In addition, the e-commerce platform service can evaluate a participant's contribution to product sales using sales information, including a route through which a product whose content is created through sponsorship is sold when the product is sold, and distribute sales money in a certain proportion according to the evaluation, so that even users with small business scale can request the creation of content without burden at a low cost, and even content creators who are not famous can receive an appropriate reward by creating content with product sponsorship. Furthermore, more profits can be shared among participants as the overall sales of the platform and the size of the market itself increase.

### BRIEF DESCRIPTION OF THE DRAWINGS

FIG. 1 is a diagram illustrating an e-commerce environment according to various embodiments.

FIG. 2 is a diagram illustrating a configuration of a platform server according to one embodiment.

FIG. 3 is a diagram illustrating a hierarchy of sellers according to one embodiment.

FIG. 4 is a diagram illustrating a process of requesting content creation on an e-commerce platform according to one embodiment.

FIG. 5 is a diagram illustrating a process of product sponsorship on an e-commerce platform according to one embodiment.

FIG. 6 is a diagram illustrating that content created through product sponsorship according to one embodiment is used on an e-commerce platform.

FIG. 7 is a diagram illustrating a process of selling a product through content created through product sponsorship according to one embodiment.

FIG. 8 is a flowchart showing a method of sponsoring a content creator with a product to according to one embodiment.

### DETAILED DESCRIPTION

Hereinafter, various embodiments disclosed in the present disclosure will be described with reference to the accompanying drawings. However, this is not intended to limit the present disclosure to the specific embodiments, and it is to be construed to include various modifications, equivalents, and/or alternatives of embodiments of the present disclosure. In addition, in order to more clearly describe characteristics of the embodiments, detailed descriptions of matters widely known to those skilled in the art to which the following embodiments belong will be omitted.

Meanwhile, in addition, terms, such as “first” and “second”, including an ordinal number used herein may be used for describing various elements, but the elements should not be limited by the terms. The terms are only used to distinguish one element from another element.

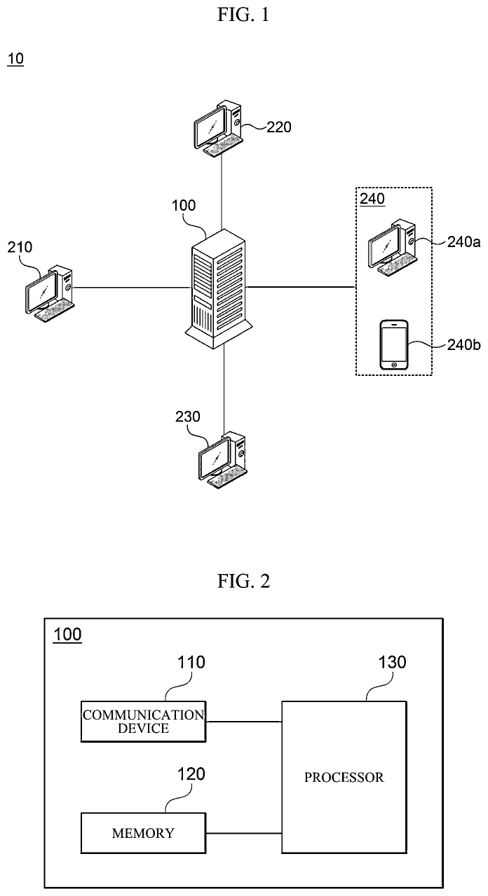

FIG. 1 is a diagram illustrating an e-commerce environment according to various embodiments.

Referring to FIG. 1, an e-commerce environment 10 may include a platform server 100, a supplier terminal 210, a seller terminal 220, a content creator terminal 230, and a purchaser terminal 240. The platform server 100 may be connected to the supplier terminal 210, the seller terminal 220, the content creator terminal 230, and the purchaser terminal 240 through a communication network.

The platform server 100 may provide an e-commerce platform service through the user terminals 210, 220, 230, and 240. The E-commerce platform service may include overall services required to sell products online, such as product supply, sales, promotion, and purchase.

According to one embodiment, the platform server 100 may provide a supplier with the services necessary to supply platform products through the supplier terminal 210.

According to one embodiment, the platform server 100 may register a supplier of a product to be sold through the supplier terminal 210 in the platform service. The supplier may be, for example, a person who supplies products to be sold in the platform service and delivers products sold by a seller. Accordingly, the supplier may be a person who is only responsible for product distribution and delivery and leaves the rest to other users. According to one embodiment, registering in the platform service may be understood as registering in the platform service as a participant performing a specified role. According to one embodiment, the supplier may be approved for registration according to specified criteria. The specified criteria may include, for example, criteria for determining the reliability of the supplier, such as a business period, a capital size, a sales size, a brand value, or the like. According to one embodiment, the supplier may be approved according to strict (or high) criteria. Accordingly, products may be stably supplied on the platform by highly reliable suppliers.

According to one embodiment, the platform server 100 may register the supplier's supply products in the platform service through the supplier terminal 210. According to one embodiment, a product may be approved for registration according to specified criteria. The specified criteria may include, for example, criteria for predicting product sales volume, such as product quality, consumer preference, brand involvement, market share, a distribution margin structure, availability of exclusive distribution, and the like. According to one embodiment, a product may be approved according to strict criteria. Accordingly, users (e.g., sellers, content creators) capable of contributing to promoting product sales by registering products with high sales volume may participate more in the platform service, generating high synergy.

According to one embodiment, the platform server 100 may provide a total solution required to supply products through the supplier terminal 210. For example, the platform server 100 may provide a solution that includes services for registering and selling supply products and managing a community. Services for managing product sales may include, for example, services that provide sales information for registered supply products, manage inventory of supply products, and manage orders, delivery, and refunds. According to one embodiment, the platform server 100 may provide settlement information about products sold through a seller's online shop. According to one embodiment, the platform server 100 may provide solutions necessary to supply products through a graphic user interface (GUI).

According to one embodiment, the platform server 100 may provide the seller with services required to sell products through the seller terminal 220.

According to one embodiment, the platform server 100 may register the seller in the platform service through the seller terminal 220. The seller may be, for example, a person who sells the supply product registered in the platform service by the supplier. According to one embodiment, sellers may be structured in a hierarchy. The hierarchy may, for example, include an upper seller and a sub seller subordinate to the upper seller. According to one embodiment, the sub seller who is subordinate to the upper seller may be subordinate to the upper seller in terms of products to be sold and sales conditions, and may be required to pay a portion of the sales amount as a commission to the upper seller. According to one embodiment, a seller may be approved for registration according to specified criteria. The specified criteria may be differently applied depending on, for example, the seller's stratum. A top seller may be approved for registration based on strict criteria based on reliability equivalent to that of a supplier, such as a sales size, a capital size, a human network size, and the like. Sub sellers (e.g., a second-stratum seller, a third-stratum seller) may be registered in the platform service with the approval of the upper seller. Accordingly, the supply product registered in the platform service may be professionally sold in various of ways in multiple online shops (or online shopping malls) under the direction of a highly reliable top seller.

According to one embodiment, the platform server 100 may register the seller's sale products in the platform service through the seller terminal 220. For example, the platform server 100 may register sale products of the top seller. In other words, the platform server 100 may allow only the top seller to apply for approval for sale of new products. For example, the sub seller of the top seller is not allowed to directly apply for sales approval of new products, but is allowed to select and sell products from within the products approved for sale by the top seller. According to one embodiment, a sale product may be approved according to specified criteria. The sale product may include, for example, criteria for determining whether the product may be sold professionally, such as the seller's activity area, capital size, existing sale products, sales volume, or the like. According to one embodiment, approval criteria for the sale product may be high. Accordingly, product information on the supply product registered in the platform service may be delivered to purchasers with high interest in the product through appropriate marketing methods by a professional seller, thereby recording high sales, which may bring a great profit not only to the supplier but also to users who contribute to product sales (e.g., the seller and the content creator).

According to one embodiment, the platform server 100 may provide a solution for creating an online shop within the platform. For example, the platform server 100 may provide a function of setting up an online shop using a drag and drop method through the GUI without hard coding. In addition, the platform server 100 may provide a pre-made design template. According to one embodiment, the platform server 100 may register a seller's sale product in an online shop. For example, the sale product may be a product approved for sale to the seller. According to one embodiment, the platform server 100 may create an online shop requested by the seller. For example, the platform server 100 may create an online shop created by each seller. Each seller may create a separate online shop according to his or her tastes. Accordingly, purchasers may selectively join an online shop that suits their tastes on the platform service and purchase products registered in the online shop as a member.

According to one embodiment, the platform server 100 may provide a sales service for products registered in the created online shop to users who visit the platform. For example, the platform server 100 may allow a user who directly visits the platform to search for products through a route within the platform (e.g., search, online shop visit) and purchase the products that are found by the searching. For example, information on products registered in the online shop may not be found by searching through a portal service (e.g., Naver and Yahoo). Accordingly, it is possible to increase user loyalty to platform services and prevent losses to suppliers and sellers due to excessive competition at the lowest prices.

According to one embodiment, the platform server 100 may provide a comprehensive solution required to sell products through the seller terminal 220. For example, the platform server 100 may provide a solution that includes services for managing the online shop and managing human resources, registration of sale products, sales of sale products, and a community of the online shop. The service for managing human resources may include, for example, a service for managing sub sellers and members. The service for managing product sales may include a service that provide sales information about products to be sold, and a service that manages orders, delivery, and refunds. According to one embodiment, the platform server 100 may provide settlement information about products sold through a seller's online shop. According to one embodiment, the platform server 100 may provide status information about the sub seller subordinate to the upper seller in the hierarchy. The status information may include, for example, information about human resources, product sales, and a community. According to one embodiment, the platform server 100 may provide a comprehensive solution required to sell products through the GUI.

According to one embodiment, the platform server 100 may provide a service required to supply content to the supplier through the content creator terminal 230.

According to one embodiment, the platform server 100 may register a content creator in the platform service. For example, the content creator may create content that helps sell a product and provide the created content to the supplier and the seller. According to one embodiment, the content creator may be an expert who is directly or indirectly required to create content. The expert may include, for example, a model, a hair and makeup expert, a stylist, a photographer, and the like. In addition, the model may be an influencer, celebrity, or the like, on online social media.

According to one embodiment, the platform server 100 may provide a service that allows content created by the content creator to be shared with platform users. For example, the platform server 100 may provide a content sharing service using platform users as a social network, in other words, a social network service (SNS). According to one embodiment, the platform server 100 may register the content creator's content in the platform service. According to one embodiment, the platform server 100 may provide the registered content to the platform users through the content sharing service. The content shared through the content sharing service may be content for promoting products to be sold on the platform service. According to one embodiment, the content may include information (e.g., URL) about an online shop within the platform where the promoted product is being sold. Accordingly, the purchaser may move to a specified shopping mall using the information and purchase the product. According to one embodiment, the platform server 100 may provide information about participants who have participated in content creation (e.g., a model, a hair and makeup expert, a stylist, a photographer, and the like) together with the content. Accordingly, the supplier and the purchaser may easily confirm not only the model but also all parties required to create content.

According to one embodiment, the platform server 100 may provide a service for connecting the supplier and the seller to the content creator. According to one embodiment, the platform server 100 may connect the supplier and the seller who wish to request the creation of content for product promotion to the content creator. For example, the platform server 100 may connect not only a model matching an image of the product but also participants required to create content, such as a hair and makeup expert, a stylist, and the like, all at once. According to one embodiment, the platform server 100 may connect the supplier and the seller who want to offer product sponsorship to a content creator. According to one embodiment, the platform server 100 may connect a content creator who is expected to create content with high promotional effectiveness to the supplier and the seller. For example, the platform server 100 may connect a content creator who is expected to have a high promotional effect based on sales or the like of the product of previously created content.

According to one embodiment, the platform server 100 may provide a sponsorship product to a content creator. For example, the platform server 100 may provide a sponsorship product to the content creator according to the request of the supplier. According to one embodiment, the supplier may make a request to the platform server 100 for supply product sponsorship. For example, the sponsorship may be for creating promotional content for the supply product. According to one embodiment, the promotional content may be intended to promote product sales within the e-commerce platform. According to one embodiment, the platform server 100 may determine a content creator to receive sponsorship for the supply product. For example, the platform server 100 may determine a content creator suitable for creating content for the supply product to be sponsored. According to one embodiment, the supplier may sponsor the determined content creator with the supply product.

According to one embodiment, the platform server 100 may receive content for the sponsorship product from the content creator who has been sponsored with the product. According to one embodiment, the platform server 100 may register the received content in a content database (DB). According to one embodiment, the platform server 100 may provide the registered content to the seller selling the sponsorship product. For example, the provided content may be uploaded to the online shop of the seller who has requested the provision. According to one embodiment, the platform server 100 may provide the registered content through a social network service (SNS). For example, the platform server 100 may upload the registered content to a space (e.g., a web page) where the content creator is identifiable.

According to one embodiment, when the product is sold through the online shop of the seller to whom the content is provided, the platform server 100 may distribute a specified proportion of the sales money of the sold product to the content creator. According to one embodiment, the platform server 100 may determine the specified proportion according to the content creator's contribution to the sold product. The contribution may be determined, for example, by the extent to whom the content created by the content creator contributes to the sales of the product. According to one embodiment, the platform server 100 may determine the contribution based on sales information on the product. The sales information may include, for example, information about sales amounts of a plurality of sellers selling the sponsorship product, the access route to the online shop where the sponsorship product is sold, or the like. Accordingly, the content creator may receive a reward for content creation.

According to one embodiment, the platform server 100 may provide the content creator with a comprehensive solution required to supply content through the content creator terminal 230. For example, the processor 130 may provide a solution including services for managing contracts, profits, and settlements with the supplier and the seller. According to one embodiment, the platform server 100 may provide profit information according to content creation. The profit information may include, for example, information about money distributed based on sales of the sponsorship product for which the content is created. According to one embodiment, the platform server 100 may provide a solution required to supply content through the GUI.

According to one embodiment, the platform server 100 may provide a purchaser with a service required to purchase a product through the purchaser terminal 240.

According to one embodiment, the platform server 100 may register a purchaser as a member in the seller's online shop. For example, the platform server 100 may register a purchaser as a member in each seller's online shop.

According to one embodiment, the platform server 100 may receive order and delivery information about a purchaser who purchases a product through an online shop. According to one embodiment, the platform server 100 may provide a payment service to a purchaser who purchases a product. According to one embodiment, the platform server 100 may transmit order information to the supplier and the seller when payment is completed. Accordingly, the supplier may deliver the ordered product to the purchaser.

According to one embodiment, the platform server 100 may provide a service for managing an order status through the purchaser terminal 240. According to one embodiment, the platform server 100 may provide order and delivery information for the product purchased from the online shop. According to one embodiment, when the platform server 100 receives order correction information, the platform server 100 may modify the order information based on the received correction information.

According to one embodiment, a manager of the platform server 100 may approve the registration of the platform service. According to one embodiment, the manager of the platform server 100 may approve registration of the platform user. For example, the manager may approve registration of the supplier and the seller. The seller for registration approval may be, for example, a top seller. According to one embodiment, the manager of the platform server 100 may approve registration of a product. For example, the manager may approve a supply product of the supplier and a sale product of the seller. For example, the sale product may be a sale product of the top seller. According to one embodiment, the manager of the platform server 100 may access the platform server 100 through a separate terminal and approve registration of the service.

According to one embodiment, the manager of the platform server 100 may confirm status information for managing the overall status of the supplier and the seller. The status information may include, for example, sales information (e.g., sales information, settlement information, delivery information, or the like), settlement information, and order and delivery information. According to one embodiment, the manager of the platform server 100 confirm community information. The community information may include, for example, an online shop, and notices, FAQs, Q&A, reviews, and the like, about products sold in the online shop.

According to one embodiment, the manager of the platform server 100 may register suppliers, sellers, and content creators introduced by a collector according to the above-described procedure. According to one embodiment, the collector is a separate entity from the manager and may play a role in encouraging more users to participate in the platform service.

According to one embodiment, the platform server 100 may include not only a computing module required to provide the e-commerce platform service, but also a database (DB) for data storage. In other words, the platform server 100 may include a server configuration generally required to provide the e-commerce service. According to one embodiment, the platform server 100 may provide useful information to service users by analyzing information stored in the database. The useful information may include, for example, basic data useful for product supply, product sales, content creation, and product purchase, and processed data.

The supplier terminal 210 may be a supplier terminal for using the e-commerce platform service provided to the supplier from the platform server 100.

According to one embodiment, the supplier terminal 210 may receive information for managing product supply from the platform server 100. For example, the supplier terminal 210 may receive information for registering a supply product, selling the supply product, and managing a community for the supply product. According to one embodiment, the supplier terminal 210 may transmit, to the platform server 100, information input from the supplier for managing product supply. For example, the supplier terminal 210 may transmit application information for registering a new supply product. In addition, the supplier terminal 210 may transmit information input from the supplier to manage orders, delivery, and a community of the supply product. According to one embodiment, the supplier terminal 210 may provide information for managing product supply to the supplier through the GUI and receive information required to manage product supply from the supplier.

The seller terminal 220 may be a seller's terminal for using the e-commerce platform service provided to the seller from the platform server 100.

According to one embodiment, the seller terminal 220 may receive a service for creating a shopping mall provided from the platform server 100. The service for creating an online shop may include information required to create a shopping mall, for example, in a manner of dragging and dropping through the GUI and providing a template. According to one embodiment, the seller terminal 220 may transmit information input from the seller to the platform server 100 to create an online shop. Accordingly, the seller's online shop may be created on the platform.

According to one embodiment, the seller terminal 220 may receive information for managing product sales from the platform server 100. For example, the seller terminal 220 may receive information for registering sale products, selling the sale products, managing human resources, and managing an online shop community. The human resource management may include, for example, managing sub sellers and members. According to one embodiment, the seller terminal 220 may transmit information input from the seller to the platform server 100 to manage product sales. For example, the seller terminal 220 may transmit an application to register a new sale product. The application for the new sale product may be done, for example, by the top seller. In addition, the seller terminal 220 may transmit information input from the seller to manage orders, delivery, and a community of the supply product. According to one embodiment, the seller terminal 220 may provide information for managing product supply to the seller through the GUI and receive information required to manage product sales from the seller.

The content creator terminal 230 may be a seller terminal for using the e-commerce platform service provided to the content creator from the platform server 100.

According to one embodiment, the content creator terminal 230 may be provided with a service for sharing content with platform users from the platform server 100. The service for sharing the content may be, for example, a social network service (SNS) using platform users as a social network. According to one embodiment, the content creator terminal 230 may transmit a created content to the platform server 100. Accordingly, the content creator's content may be shared on the platform.

According to one embodiment, the content creator terminal 230 may receive content creating request and sponsorship offer information from the platform server 100. For example, the content creator terminal 230 may receive sponsorship information upon request from the supplier. The sponsorship information may include, for example, sponsorship offer information for content creation for the supply product. According to one embodiment, the content creator terminal 230 may transmit a response indicating acceptance of the creation request and sponsorship offer to the platform server 100. Accordingly, a content creation or sponsorship contract with the supplier or seller may be made.

According to one embodiment, the content creator terminal 230 may receive information for managing content creation from the platform server 100. For example, the content creator terminal 230 may receive contract information, profit information, and settlement information from the platform server 100. According to one embodiment, the content creator terminal 230 may provide the received information to the seller through the GUI and receive information required to manage content creation and sponsorship contracts from the content creator.

The purchaser terminal 240 may be a purchaser terminal for using the e-commerce platform service provided to the purchaser from the platform server 100.

According to one embodiment, the purchaser terminal 240 may receive online shop information. According to one embodiment, the purchaser terminal 240 may transmit information on a consumer's order. Accordingly, a product purchase may be made.

According to one embodiment, the user terminals 210, 220, 230, and 240 may be a general-purpose device such as a desktop personal computer, a laptop PC, a smartphone, a tablet PC, and a personal digital assistant (PDA). For example, the supplier terminal 210, the seller terminal 220, and the content creator terminal 230 may be electronic devices with relatively low portability, such as desktop PCs and laptop PCs, and the purchaser terminal 240 may be a smartphone 240b as well as a desktop PC 240a with low portability.

In the e-commerce environment 10 described above, suppliers who supply products, sellers who create online shops to sell products, and creators who create content to promote products may coexist on one platform and provide an e-commerce platform service that sells products to purchasers and shares the profit from product sales.

FIG. 2 is a diagram illustrating a configuration of a platform server according to one embodiment.

Referring to FIG. 2, a platform server 100 may include a communication device 110, a memory 120, and a processor 130. However, not all of the components illustrated are essential components. The platform server 100 may be implemented with more components than the illustrated components, and the platform server 100 may be implemented with fewer components than the illustrated components.

The communication device 110 may communicate with an external device. For example, the communication device 110 may be connected to a network by wire or wirelessly to communicate with an external device. Here, the external device may be a user terminal (e.g., the user terminals 210, 220, 230, and 240 in FIG. 1).

The communication device 110 may include a communication module that supports one of various wired and wireless communication methods. The communication module may be a short-distance communication module or a wired communication module.

The memory 120 may include at least one storage medium of a flash memory type memory, a hard disk type memory, a multimedia card micro type memory, a card type memory (SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

The memory 120 may store at least one program for providing product supply, product sales, content provision, and an e-commerce platform service in which buying users participate on the platform server 100. The at least one program stored in the memory 120 may be classified into a plurality of modules according to function.

The memory 120 may include a DB for registering information on products, suppliers, sellers, content creators, and purchasers. However, the DB is a separate storage device and may be implemented outside of the platform server 100 and connected directly or through a communication network.

The processor 130 may control the overall operation of the platform server 100 and include at least one processor such as a CPU. The processor 130 may include at least one specialized processor corresponding to each function, or may be an integrated processor.

The processor 130 may execute a program stored in the memory 120, read data or files stored in the memory 120, or store a new file in the memory 120. In addition, the processor 130 may execute instructions stored in the memory 120. Accordingly, the processor 130 may perform the following operations.

The operation performed by instruction execution of the processor 130 may be understood as the operation of a platform server (e.g., the platform server 100 in FIG. 1).

According to one embodiment, the processor 130 may register a supplier of a product to be sold in the platform service in a supplier DB through a supplier terminal (e.g., the supplier terminal 210 in FIG. 1). According to one embodiment, registering in the DB may be understood as storing information about a subject to be registered. In addition, storing information about the subject in the DB may be understood as registering the subject in the platform service.

According to one embodiment, the processor 130 may register a supply product in a supply product DB through the supplier terminal. The supply product may be, for example, a supplier's product to be sold on the platform service.

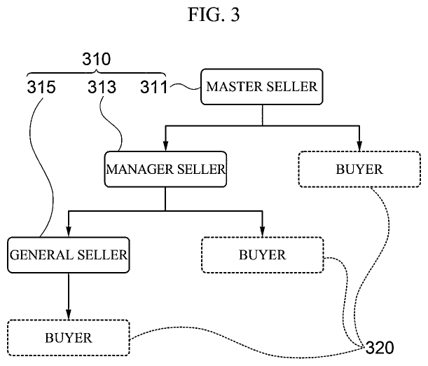

According to one embodiment, the processor 130 may register a seller in a seller DB through a seller terminal (e.g., the seller terminal 220). For example, when registering a plurality of sellers in the seller DB, the processor 130 may register the sellers in the seller DB in a hierarchy including an upper seller and at least one sub seller subordinate to the upper seller. According to one embodiment, in the seller DB, the processor 130 may register a top seller in the hierarchy as a master seller, and register a sub seller subordinate to the top seller as a manager seller and register a sub seller subordinate to the manager seller as a general seller. According to one embodiment, the processor 130 may grant designated authority to the manager seller to manage the general seller. The hierarchy will be described in more detail in FIG. 3.

According to one embodiment, the processor 130 may register a sale product in a sale product DB through the seller terminal. For example, the processor 130 may register the top seller's sale products in the sale product DB. For example, the sale product may be at least one of the supply products registered in the supply product DB. In other words, at least one of the supply products registered by the suppliers may be selected and registered as a sale product.

According to one embodiment, the processor 130 may allow sub sellers subordinate to the top seller to sell products within the top seller's registered sale products. In other words, the products sold by the sub sellers are subordinate to the registered sale products of the top seller to whom the sub sellers are subordinate.

According to one embodiment, the processor 130 may create an online shop for each of a plurality of sellers registered through the seller terminal. For example, the processor 130 may create online shops for sub sellers subordinate to the top seller. For example, the created online shop may include at least one of the registered sale products of the top seller registered in the sale product DB. In addition, online shops of not only the sub sellers but also the top seller may be created.

According to one embodiment, the processor 130 may set an earning rate for distributing the profit from the sale of products through the seller terminal. According to one embodiment, the processor 130 may receive information for setting the earning rate according to the hierarchy of the sellers from the terminal of the top seller. According to one embodiment, the processor 130 may set the earning rate for sellers in the hierarchy according to information for setting the received earning rate. The set earning rate may be for distribution of the profits, for example, the amount obtained by excluding a supply price of the supplier and a content creator's contribution from the amount of the sale of products.

According to one embodiment, the processor 130 may register a content creator in a content creator DB through a content creator terminal (e.g., the content creator terminal 230 in FIG. 1). For example, the processor 130 may register a plurality of content creators in the content creator DB. According to one embodiment, the processor 130 may receive application information for registering as a content creator from the content creator terminal. The application information may include, for example, information capable of identifying a content creator. According to one embodiment, the processor 130 may register a content supplier based on the received application information. The content creator may be, for example, an expert directly or indirectly required to create content.

According to one embodiment, the processor 130 may provide a service for sharing content with platform users through the content creator terminal. According to one embodiment, the processor 130 may receive content for promoting a product registered in at least one of the supply product DB and the sale product DB from the content creator terminal. According to one embodiment, the processor 130 may register the received content in a content DB. According to one embodiment, the processor 130 may provide content registered in the content DB to the platform users. For example, the processor 130 may provide a purchaser with content uploaded to a space in which the content creator is identifiable through a purchaser's terminal. The content may be, for example, content requested by the supplier or the seller through the platform service.

According to one embodiment, the processor 130 may provide a service for connecting the supplier and the seller to the content creator through the content creator terminal. For example, the processor 130 may request content creation for promoting a product or connect a content creator for product sponsorship. According to one embodiment, the processor 130 may upload the connected content to the seller's online shop and provide the content to users of the platform service. For example, the processor 130 may provide a product purchase page with the uploaded content through a purchaser terminal.

According to one embodiment, the processor 130 may provide recommendation information on content creators expected to have a high promotional effect through the supplier terminal and the seller terminal. The recommendation information may be provided, for example, based on information about content that has been previously created.

According to one embodiment, the processor 130 may provide a sponsorship product to the content creator. For example, the processor 130 may provide a sponsorship product to the content creator according to the request of the supplier.

According to one embodiment, the processor 130 may receive the request to offer supply product sponsorship from the supplier terminal. For example, the sponsorship may be for creating promotional content for the supply product. According to one embodiment, the request for the supply product may include information about sponsorship conditions. The sponsorship condition information may include, for example, information on whether a sponsorship product is provided free of charge and information on a numerical value required to distribute sales money.

According to one embodiment, the processor 130 may determine at least one content creator to receive sponsorship for the supply product in response to the received request.

According to one embodiment, the processor 130 may determine at least one content creator to receive sponsorship for the supply product based on history information about previously created content. For example, the processor 130 may determine a content creator who has a history of creating content for a product included in the same category as the supply product to be sponsored as at least one content creator to receive sponsorship for the supply product. The category may be, for example, a concept for classifying products according to the type, purpose, or the like, of the products. According to one embodiment, the category for determining the content creator may be determined based on similarity of conditions (or environments) for creating content. For example, the category may be divided based on similarity in content creation conditions (e.g., a creation environment, content type, content details) of the content. The similarity in the creation conditions may be identified, for example, through analysis of the previously created content within the e-commerce platform. According to one embodiment, the processor 130 may confirm the creation conditions of the content by analyzing the content registered in the content DB. According to one embodiment, the processor 130 may update the category for determining the content creator through the confirmed conditions. According to one embodiment, since the content created within the platform is registered and managed in the content DB, analysis for determining the category may be easier compared to other e-commerce platforms.

According to one embodiment, the processor 130 may determine the ranking of a plurality of content creators. For example, the processor 130 may determine the ranking of the plurality of content creators based on at least one of the number of times previously created content is used in the online shop of the seller and a sales amount of the used product. According to one embodiment, the processor 130 may determine the ranking of the plurality of content creators determined based on the history information about previously created content. According to one embodiment, since content creation for products and a sales history of the products using the created content are stored in the DB within the platform, analysis for determining the ranking may also be easier compared to other e-commerce platforms. According to one embodiment, the processor 130 may allow new content creators creating a specified number of content items or less to be included in the specified ranking at a specified proportion among the plurality of content creators. For example, the processor 130 may assign a weight to an evaluation score of the content creator's content so that the new content creators are included in the specified proportion. For example, the evaluation score may be a score calculated to evaluate the content creators. According to one embodiment, the processor 130 may determine content creators within the specified ranking as at least one content creator who is to receive sponsorship for the supply product of the supplier.

According to one embodiment, the processor 130 may provide sponsorship condition information to the determined at least one content creator. The sponsorship condition information may include, for example, information on whether a sponsorship product is provided free of charge and information on a numerical value required to distribute sales money. According to one embodiment, the processor 130 may receive the sponsorship condition information from the supplier terminal. For example, the sponsorship condition information may be received together with the request to offer supply product sponsorship by being included therein.

According to one embodiment, when receiving a user input accepting the sponsorship conditions from the content creator terminal, the processor 130 may request the supplier to sponsor the at least one content creator who has accepted the sponsorship conditions. Accordingly, the supplier may sponsor the content creator with the supply product according to the above request.

According to one embodiment, the processor 130 may request the at least one content creator to create content for the sponsored supply product. For example, when it is confirmed that the content creator has received sponsorship for the supply product, the processor 130 may request the content creator to create content for the supply product. Sponsorship confirmation of the supply product may be performed, for example, through a user input (e.g., sponsorship confirmation input) received from the content creator terminal.

According to one embodiment, the processor 130 may receive the content created in response to the request to create content from the content creator terminal. According to one embodiment, the processor 130 may register the received content in the content DB.

According to one embodiment, the processor 130 may provide the content for the supply product, which is created by the at least one content creator who has received sponsorship of the supply product, to at least one seller selling the supply product. For example, when receiving a request to provide the content for the supply product from the seller terminal, the processor 130 may upload the content for the supply product to an online shop of a seller who requests the content. For example, the registered content may be registered in the content DB. According to one embodiment, the content for the supply product may be uploaded to a sales space of the online shop. The sales space may be, for example, a page for selling products (or a sales page).

According to one embodiment, when the sponsored supply product is sold through the online shop of the seller to whom the content is provided, the processor 130 may distribute a specified proportion of the sales money of the sold product to the at least one content creator.

According to one embodiment, the processor 130 may determine the specified proportion according to a contribution of the at least one content creator to sales of the supply product. For example, when the contribution of the content creator is high, the processor 130 may determine a proportion higher than the specified proportion. In addition, when the contribution of the content creator is low, the processor 130 may determine a proportion lower than the specified proportion.

According to one embodiment, the processor 130 may determine the contribution of the at least one content creator based on the sales amounts of the supply product of a plurality of sellers selling the supply product. According to one embodiment, the processor 130 may determine the contribution of the content creator based on a difference in sales amounts of the supply product by a plurality of sellers. The difference in sales amounts of the supply product may be, for example, a difference in sales amounts depending on whether or not the content for the supply product is used. According to one embodiment, the processor 130 may determine the contribution of the content creator to be high when the difference in sales amounts is greater than or equal to a specified amount. For example, the processor 130 may determine the contribution to be high by assigning a weight to a specified numerical value. According to one embodiment, the processor 130 may determine the contribution of the content creator to be low when the difference in sales amounts is less than the specified amount. For example, the processor 130 may determine the contribution to be low by assigning a specified numerical value. For example, the specified numerical value may be a numerical value basically recognized by the content creator who has created the content. In other words, the specified numerical value may be a numerical value recognized simply by creating the content, regardless of the promotional effect of the content. According to one embodiment, the processor 130 may determine the contribution of the content creator step by step through a plurality of sections determined by a plurality of specified amounts.

According to one embodiment, when determining the contribution of a content creator based on the sales amount of the seller, the processor 130 may determine the contribution of the at least one content creator based on the sales amount of a sub seller in the hierarchy of the plurality of sellers. For example, the processor 130 may determine the contribution of the content creator based on the sales amount of the lowest seller whose main role in the hierarchy is to sell products. The lowest seller may be, for example, a general seller.

According to one embodiment, the processor 130 may determine the contribution of the at least one content creator based on an access route to the online shop where the supply product is sold. According to one embodiment, the processor 130 may provide the content of the content creator to the purchaser through a space in which the content creator is identifiable. The space in which the content creator is identifiable may be, for example, a page for sharing content provided through a social network service (SNS) (or a content sharing page). According to one embodiment, the processor 130 may determine the contribution of the at least one content creator to be high when the purchaser accesses the online shop where the supply product is sold through the content of the space. For example, the processor 130 may determine the contribution to be high by assigning a weight to a specified numerical value. For example, the specified numerical value may be a numerical value basically recognized by the content creator who has created the content.

According to one embodiment, since information on the use of registered content, sales information according to product sales, and information on product sales routes are stored in the DB within the platform, analysis to determine the contribution may also be easier compared to other e-commerce platforms.

According to one embodiment, a numeral value required to determine the contribution of the content creator may be determined by the supplier offering supply product sponsorship. For example, the specified number and weight for determining the contribution may be determined by the supplier. Information about the numerical value may be included in, for example, the sponsorship condition information.

Accordingly, the content creator may receive the reward for contributing to product sales by creating content for the sponsored product.

According to one embodiment, the processor 130 may provide a purchaser with a service required to purchase a product through a purchaser terminal (e.g., the purchaser terminal 240 in FIG. 1). According to one embodiment, the processor 130 may receive purchase information about a purchaser who has purchased a product from the purchaser terminal. According to one embodiment, the processor 130 may transmit the received order information to the supplier terminal and the seller terminal when payment is completed. For example, the processor 130 may transmit the received order information to the supplier terminal to cause the supplier to deliver the product to the purchaser.

Accordingly, the platform server 100 may provide the platform service for selling products online.

FIG. 3 is a diagram illustrating a hierarchy of sellers according to one embodiment.

Referring to FIG. 3, a plurality of sellers 310 may be registered in a hierarchy including a top seller and a sub seller.

According to one embodiment, a plurality of sellers 310 may connect to a platform server (e.g., the platform server 100 in FIG. 1) through a seller terminal (e.g., the seller terminal 220 in FIG. 1) to transmit and receive information for using a platform service. The actions (or operations) of the plurality of sellers 310 below may be understood as being performed through seller terminals.

According to one embodiment, the hierarchy of the plurality of sellers 310 may include an upper seller and a sub seller subordinate to the upper seller. The sub seller being subordinate to the upper seller may mean that the authority of the sub seller within the platform service is subordinate to the authority of the upper seller. In other words, being subordinate may mean that the authority of the sub seller may be determined within the authority of the upper seller. The authority may relate to the scope of determination that may be made when a product is registered in the platform service and is sold, for example, whether the seller is registered, products to be sold, sales conditions, or the like.

According to one embodiment, the hierarchy of a plurality of sellers 310 may include a plurality of layers. For example, each of the plurality of layers may be sequentially subordinate to a higher layer. According to one embodiment, the hierarchy of the plurality of sellers 310 may include a master seller 311, a manager seller 313, and a general seller 315. In addition, the hierarchy of the plurality of sellers 310 may include three or more layers. For example, the hierarchy the plurality of sellers 310 may register the manager seller 313 including a plurality of layers.

According to one embodiment, the master seller 311 may be the top seller in the hierarchy. In other words, the master seller 311 may not have an upper seller to whom the master seller is subordinate.

According to one embodiment, the master seller 311 may register a sale product in the platform service. The sale product may be, for example, at least one of supply products registered in the platform service by suppliers.

According to one embodiment, the master seller 311 may manage subordinate sub sellers (or the manager seller 313 and the general seller 315).

According to one embodiment, the master seller 311 may determine whether to register subordinate sub sellers 313 and 315. For example, the master seller 311 may determine whether to register not only the manager seller 313, which is directly subordinate to the master seller, but also the general seller 315, which is indirectly subordinate to the master seller through the manager seller 313.

According to one embodiment, the master seller 311 may set the earning rate for the sub sellers 313 and 315. The earning rate may be, for example, a proportion in which the profit from the sale of products by sub sellers 313 and 315 are distributed according to the hierarchy. According to one embodiment, the sales money of the product may be distributed to the supplier, the seller, and the content creator. For example, the sales money of the product may be distributed according to the contributions of the supplier, the seller, and the content creator to product sales. According to one embodiment, the profit distributed to the seller in the hierarchy may be the amount obtained by excluding the amounts distributed to the supplier and the content creator. The amount distributed to the supplier may be, for example, a supply amount of the product. The amount distributed to the content creator may be a reward amount for content creation. According to one embodiment, the reward amount distributed to the content creator may be determined based on the extent to whom the created content contributes to product sales.

According to one embodiment, the master seller 311 may confirm a sales status, delivery status, and settlement status of the registered sub sellers 313 and 315.

According to one embodiment, the master seller 311 may create an online shop directly operated by the master seller 311. In the created online shop, for example, sale products of the master seller 311 may be registered. According to one embodiment, the master seller 311 may sell the products to a purchaser 320 through the created online shop.

According to one embodiment, rather than directly selling products to the purchaser 320 through the online shop, the master seller 311 may focus more on registration of the sale product and management of the subordinate sub sellers 313 and 315. According to one embodiment, since the profit of the master seller 311 may be distributed from the sales profit of the sub sellers 313 and 315 according to a set earning rate, the master seller 311 may focus on managing the sale products and sub sellers 313 and 315 rather than directly selling the products. Accordingly, the master seller 311 is the top seller in the hierarchy and may play a major role in registering sale products and managing sub sellers, thereby increasing the profit not only for himself but also for the entire seller group centered on the master seller 311.

According to one embodiment, the manager seller 313 may be a middle seller in the hierarchy. In other words, the manager seller 313 may have an upper seller to whom the manager seller is subordinate and a sub seller who is subordinate to the manager seller.

According to one embodiment, the manager seller 313 may manage a subordinate sub seller (or general seller 315). According to one embodiment, the manager seller 313 may determine whether to register the general seller 315 and confirm the sales status, delivery status, and settlement status of the general seller 315. In other words, the manager seller 313 may be granted a specified authority to manage the general seller 315.

According to one embodiment, the manager seller 313 may create an online shop directly operated by the manager seller 313. According to one embodiment, the manager seller 313 may sell products within the registered sale products of the master seller 311. According to one embodiment, the manager seller 313 may sell the products to the purchaser 320 through the created online shop.

According to one embodiment, the manager seller 313, like the master seller 311, may focus more on management of the subordinate general seller 315 rather than directly selling products to the purchaser 320 through the online shop. According to one embodiment, since the profit of the manager seller 313 may be distributed from the sales profit of the general seller 315 according to the set earning rate of the master seller 311, the master seller 311 may focus more on the management of the general seller 315 rather than directly selling the products. Accordingly, the manager seller 313 is a middle seller in the hierarchy, and may perform a main role (or middle manager role) of managing the general seller 315, thereby increasing the profit of not only the manager seller but also the entire seller group centered on the master seller 311.

According to one embodiment, the general seller 315 may be the lowest seller in the hierarchy. In other words, the general seller 315 may not have a subordinate sub seller.

According to one embodiment, the general seller 315 may create an online shop in which at least one sale product of the master seller 311 is registered. According to one embodiment, the general seller 315 may sell products within the registered sale products of the master seller 311. According to one embodiment, the general seller 315 may sell the products to the purchaser 320 through the created online shop.

According to one embodiment, the general seller 315, unlike the upper sellers 311 and 313, may focus more on directly selling products to the purchaser 320 through the online shop. According to one embodiment, the general seller 315 may select at least one product to be sold in his/her online shop among the products registered by the master seller 311. For example, the general seller 315 may sell products with expertise or select products that have a high sales rate when sold together. For example, the products with a high sales rate when sold together may be products that visitors to the online shop are likely to purchase together. According to one embodiment, the general seller 315 may set the design of the online shop that will sell the selected product. For example, the general seller 315 may set a layout of a configuration of the online shop and the contents included in the configuration (e.g., product classification, list, description, and the like). Accordingly, the general seller 315 is the lowest seller in the hierarchy and may perform the main role of selling products.

According to one embodiment, the platform server (e.g., the platform server 100 in FIG. 1) may distribute a specified proportion of the sales money of the product to the content creator according to the contribution of the content creator. According to one embodiment, the platform server may determine the contribution of the content creator based on information about the sales amounts of a plurality of sellers. For example, the platform server may determine the contribution of the content creator based on a difference in sales amounts of a plurality of sellers depending on whether or not the content is used. According to one embodiment, the platform server may determine the contribution of the content creator based on the sales amount of the general seller 315. According to one embodiment, as described above, due to the nature of the hierarchy, the main role of the general seller 315 may be to sell products. Accordingly, in sales amount of the general seller 315, the difference in sales amounts due to differences in methods of selling products, such as whether content is used or not, may be clearly confirmed. On the other hand, as the master seller 311 and the manager seller 313 focus on roles other than product sales, the sales amounts may fluctuate for reasons other than methods of selling products (e.g., negligence in managing product sales), and thus the difference in sales amounts depending on the promotional effect of content may not be clearly confirmed. According to one embodiment, since the roles of sellers are clearly divided according to the hierarchy, it may be easy to analyze the effectiveness of content compared to other e-commerce platforms.

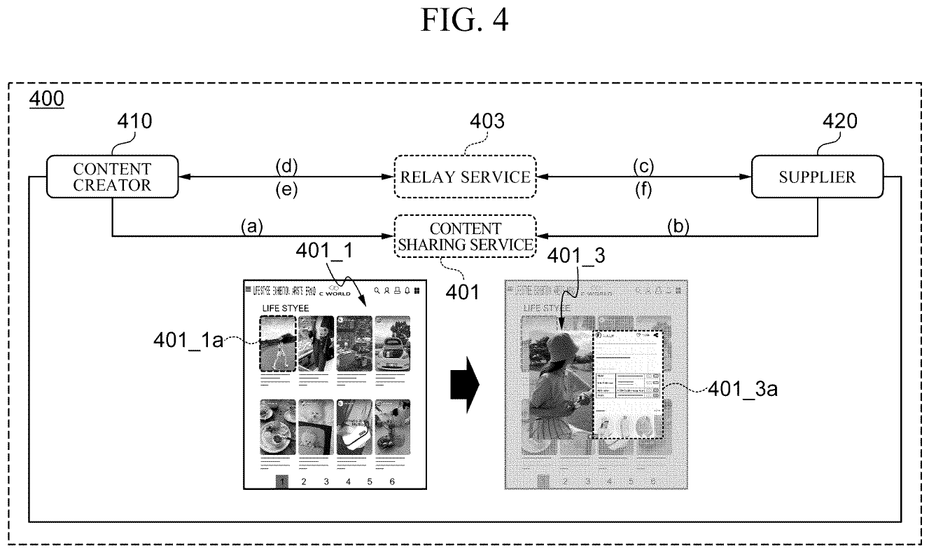

FIG. 4 is a diagram illustrating a process of requesting content creation on an e-commerce platform according to one embodiment.

Referring to FIG. 4, a platform server (e.g., the platform server 100 in FIG. 1) may connect a content creator 410 to a supplier 420 on an e-commerce platform 400.

According to one embodiment, the platform server may provide content created by a content creator 410 to platform users through a content sharing service 401. For example, the platform server may provide the created content through a space in which the content creator 410 is identifiable. The space in which the content creator 410 is identifiable may be, for example, a content sharing page of the content creator on a social network service (SNS). According to one embodiment, the platform server may connect the content creator 410 to the supplier 420 to create content for a supply product through a relay service 403. The connected content creator 410 may be determined, for example, based on the selection of the supplier 420 or previously created content.

According to one embodiment, in step (a), the content creator 410 may upload the created content to the content sharing service 401. For example, the uploaded content may be content that has been previously created by the request of another supplier.

According to one embodiment, in step (b), the supplier 420 may confirm content 401_1 of a plurality of content creators through the content sharing service 401. According to one embodiment, the supplier 420 may select one content item 401_1a from a plurality of content items. According to one embodiment, the supplier 420 may confirm a page 401_3 in which the selected content item 401_1a has been uploaded. The page 401_3 provided to the supplier 420 may include, for example, information 401_3a about the content. According to one embodiment, the information 401_3a about the content may include information about the content creator 410 and the product related to the content. For example, the information about the content creator 410 may include not only a model appearing in the content, but also information about staff who participated in content creation, such as a hair and makeup expert, a stylist, a photographer, and the like. The Information about the product related to the content may include sales information about the product included in the content (e.g., information about online shops selling the product). According to one embodiment, the product included in the content may be a sponsored product to create the content.

According to one embodiment, in step (c), the supplier 420 may request a connection with the content creator 410 who is to create promotional content for the supply product through the relay service 403. For example, the supplier 420 may request a connection to the content creator confirmed through step (b). The request may include, for example, information about creation conditions. According to one embodiment, the supplier 420 may request a connection to a content creator without specifying a specific content creator. According to one embodiment, when there is no specification of the specific content creator, the platform server may determine a content creator 410 to recommend to the supplier 420 based on previously created content. For example, the platform server may determine the content creator based on sales of the product for which the content has been previously created. According to one embodiment, the platform server may additionally perform an approval process of the supplier 420 for the determined content creator 410.

According to one embodiment, in step (d), the platform server may transmit the request of the supplier 420 to the content creator 410. For example, the platform server may transmit creation conditions included in the request of the supplier 420 to the content creator 410.

According to one embodiment, in step (e), the content creator 410 may respond to the request of the supplier 420 through the relay service 403. For example, the content creator 410 may respond by agreeing to the content creation conditions.

According to one embodiment, in step (f), the platform server may transmit the response of the content creator 410 to the supplier 420. For example, the platform server may transmit a response agreeing to the request to create the content for the supply product to the supplier 420. Accordingly, the content creator 410 and the supplier 420 may be connected to each other to communicate with each other on the e-commerce platform 400, and may cooperate to create the content for the supply product.

According to one embodiment, when the content creator 410 does not agree to the content creation conditions, the platform server may perform a communication process for coordinating the content creation conditions between the content creator 410 and the supplier 420. For example, the platform server may transmit modified creation conditions of the content creator 410 to the supplier 420 and transmit a response agreeing to the creation conditions from the supplier 420 to the content creator 410. Accordingly, the process of creating content between the content creator 410 and the supplier 420 may proceed under the modified conditions.

According to one embodiment, the relay service 403 connecting the content creator 410 may be performed not only by the supplier 420 but also by the seller. Like the supplier 420, the seller may request a connection to the content creator 410 for creating content for the sale product. However, due to the nature of the e-commerce platform service provided through the platform server, there may be more cases where requests are made through the supplier 420.

Accordingly, content created through the relay service 403 on the e-commerce platform 400 may not only be provided to sellers selling the supply product, but may also be provided to other users through the content sharing service 401.

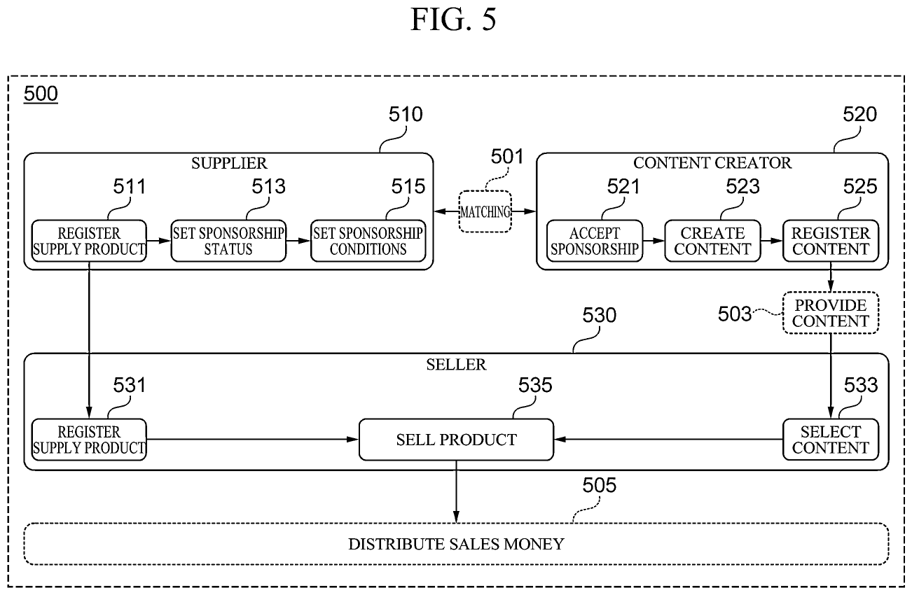

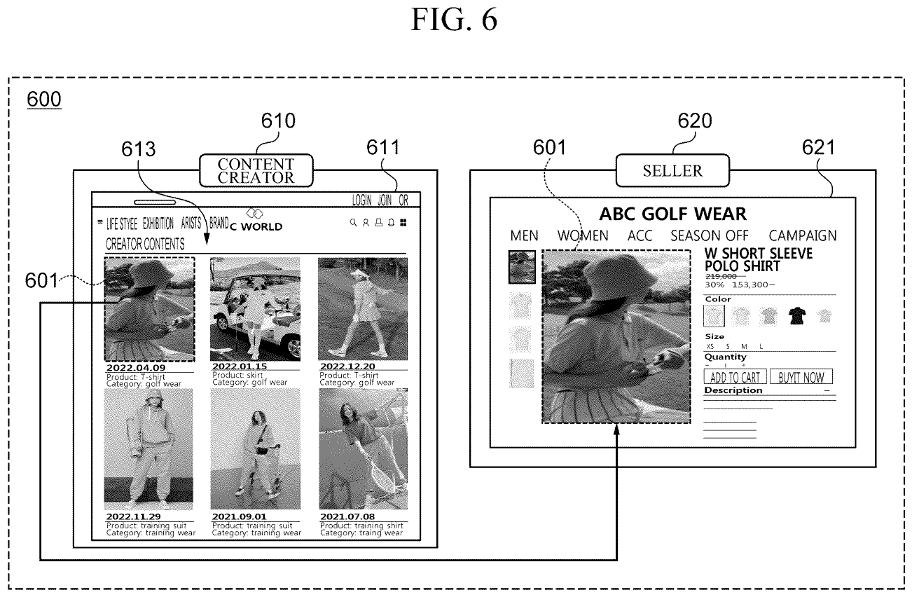

FIG. 5 is a diagram illustrating a process of product sponsorship on an e-commerce platform according to one embodiment.

Referring to FIG. 5, a platform server (e.g., the platform server 100 in FIG. 1) may provide supply products of a supplier 510 on an e-commerce platform 500 (e.g., the e-commerce platform 400 in FIG. 4) to a content creator 520 as a sponsorship product.

According to one embodiment, in step 511, the supplier 510 may register the supply products in the e-commerce platform 500. The registered supply product may be, for example, a product to be sold on the e-commerce platform 500.

According to one embodiment, in step 513, the supplier 510 may set a sponsorship status for the registered supply product. For example, the supplier 510 may set sponsorship for a product that requires content creation among at least one supply product. For example, the supply product for which the sponsorship is set may be provided to a content creator 520 as a sponsorship product, allowing the content creator 520 to create content for the supply product. According to one embodiment, the sponsorship setting for the supply product may be a form of a request to offer supply product sponsorship.

According to one embodiment, in step 515, the supplier 510 may set sponsorship conditions for the supply product for which the sponsorship is set. The sponsorship conditions may include, for example, information on whether the sponsorship product is provided free of charge and information on a numerical value required to distribute sales money. According to one embodiment, the sponsorship conditions may be included in the sponsorship request and set together with the sponsorship status.

According to one embodiment, in step 501, the platform server may match the supplier 510 and the content creator 520. For example, the platform server may determine at least one content creator 520 to receive sponsorship for the supply product of the supplier 510 based on history information about previously created content. According to one embodiment, the platform server may determine a content creator who has a history of creating content for a product of the same category as the supply product to be sponsored as at least one content creator 520 to receive sponsorship for the supply product. According to one embodiment, the platform server may determine ranking of the plurality of determined content creators and determine a content creator within a specified ranking as at least one content creator 520 to receive sponsorship for the supply product. According to one embodiment, the platform server may provide sponsorship condition information set in step 515 to the determined at least one content creator 520.

According to one embodiment, in step 521, the content creator 520 may confirm the sponsorship conditions of the supplier 510 matched by the platform server and accept the sponsorship of the supply product. Information about the content creator 520 who has accepted the sponsorship may be transmitted, for example, to the supplier 510 who has requested the sponsorship. According to one embodiment, the content creator 520 may receive a sponsorship product from the supplier 510.

According to one embodiment, in step 523, the content creator 520 may create content for the sponsored supply product. The content may include, for example, images (e.g., photos, videos) that may promote products.

According to one embodiment, in step 525, the content creator 520 may register the created content in the e-commerce platform 500.

According to one embodiment, in step 503, the platform server may provide the registered content to a seller 530 selling the supply product. For example, the platform server may provide the registered content according to the request of the seller 530.

According to one embodiment, in step 531, the seller 530 may register a sale product to be sold in an online shop. For example, a top seller may register sale products to be sold in online shops of the top seller and subordinate sub sellers. According to one embodiment, the seller 530 may create an online shop to sell the registered product. For example, the online shop may include a corresponding page for selling at least one product.

According to one embodiment, in step 533, the seller 530 may select content registered in the e-commerce platform 500 to sell the product using the content for the sale product. For example, the registered content may be content created by the sponsorship of the supply product registered as the sale product. According to one embodiment, the selected content may be uploaded to the online shop. For example, the content may be uploaded to a page for selling the product.

According to one embodiment, in step 535, the seller 530 may sell the product through the online shop. For example, the seller 530 may sell a product through a sales page of the online shop that includes the content for the product.

According to one embodiment, in step 505, the platform server may distribute the sales money of the sold product. For example, the platform server may distribute a specified proportion of the sales money of the sold product to the content creator 520. The sales money may include, for example, an amount to be distributed to the supplier 510 and the seller 530. According to one embodiment, the platform server may determine the specified proportion according to the contribution of the content creator 520 to the sold product. The contribution may be determined based on, for example, sales information about the product.

Accordingly, the supplier 510 may sponsor the content creator 520 with the supply product, to create the content for the supply product, and provide the created content to the seller 530.

FIG. 6 is a diagram illustrating that content created through product sponsorship according to one embodiment is used on an e-commerce platform.

Referring to FIG. 6, a platform server (e.g., the platform server 100 in FIG. 1) may register content 601 created through product sponsorship on an e-commerce platform 600 (e.g., the e-commerce platform 500 in FIG. 5).

According to one embodiment, the platform server may sponsor a content creator 610 with golf wear tops. According to one embodiment, the platform server may determine a content creator who has created content in the same sportswear category as the golf wear top as the content creator 610 to receive sponsorship for the golf wear top. For example, the determined content creator 610 may be a content creator by whom sportswear content that has previously been created is frequently used in an online shop or by whom a product for which the content has been created has high sales. According to one embodiment, the content creator 610 may create the content 601 for sponsored golf wear tops.

According to one embodiment, the platform server may upload the created content 601 to a space 611 where the content creator 610 is identifiable. For example, the platform server may upload the golf wear top content 601 to a content sharing page 611 of the content creator 610 on a content sharing service (e.g., the content sharing service 401 in FIG. 4). For example, the content sharing page 611 of the content creator 610 may include a plurality of content items 613 in the sportswear category that the content creator 610 has previously created.

According to one embodiment, the platform server may register the content 601 uploaded to the space of the content creator 610 in the online shop of the seller 620. For example, the platform server may upload the golf wear top content 601 to a sales page 621 for the supply product on the online shop. The uploaded content 601 may be provided, for example, with a plurality of reference images of the product. According to one embodiment, the platform server may upload the registered content 601 according to a request of the seller 620 selling the supply product.

Accordingly, purchasers may confirm the content uploaded to the sales page of the product and purchase the product.

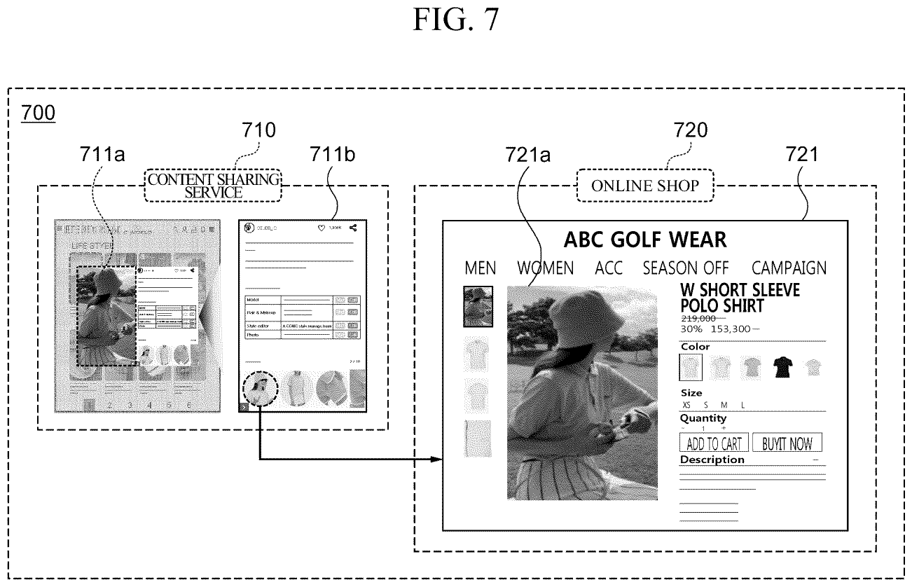

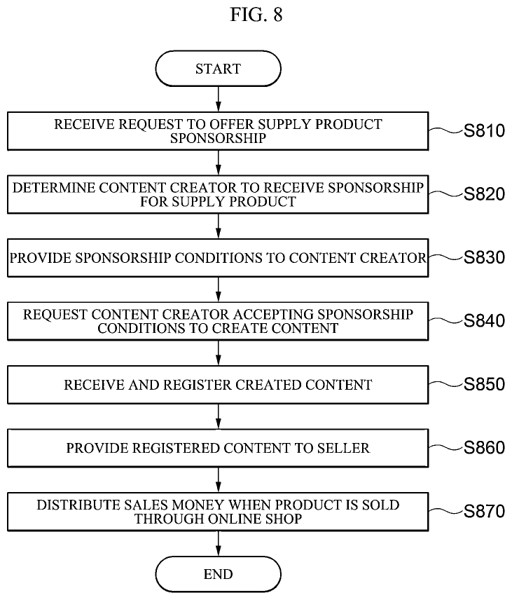

FIG. 7 is a diagram illustrating a process of selling a product through content created through product sponsorship according to one embodiment.

Referring to FIG. 7, a platform server (e.g., the platform server 100 in FIG. 1) may sell products through content 701 registered in an e-commerce platform 700 (e.g., the e-commerce platform 600 in FIG. 6).

According to one embodiment, the platform server may provide content of a plurality of content creators to platform users through a content sharing service 710. For example, the platform server may provide the content to the purchaser. According to one embodiment, the platform server may provide the purchaser with a content sharing page 711 where golf wear top content 711a is uploaded according to the purchaser's selection. According to one embodiment, the platform server may provide information 711b about the content together with the golf wear top content 711a. According to one embodiment, the information 711b about the content may include information about the content creator and a related product. The information about the related product may include, for example, information about an online shop selling golf wear worn by a content model, including sponsored golf wear tops. According to one embodiment, the information on the online shop may include link information (e.g., address information about the online shop).

According to one embodiment, the purchaser may move to an online shop 720 of a seller selling golf wear tops through the sales information. For example, the purchaser may move to a sales page 721 for golf wear tops. According to one embodiment, the sales page 721 for golf wear tops may include golf wear top content 721a. For example, the golf wear top content 721a on the sales page 721 may be posted in parallel with other images for describing a product. According to one embodiment, the purchaser may purchase a product through the sales page 721.

According to one embodiment, when a golf wear top is sold through the online shop 720 where the golf wear top content 721a is uploaded, the platform server may distribute a specified proportion of the sales amount to the content creator. The specified proportion may be determined, for example, based on the contribution of the content creator to sales of the golf wear top. The contribution may be determined based on, for example, sales information for golf wear tops. According to one embodiment, when the platform server accesses the seller's online shop 720 through the golf wear top content 711a on the content sharing service 710, the platform server may evaluate the contribution of the content creator to be high. For example, the contribution may be evaluated to be higher than when the purchaser purchases a golf wear top by directly visiting the online shop 720 where the golf wear top content 721a is uploaded through a different route.

FIG. 8 is a flowchart showing a method of sponsoring a content creator with a product to according to one embodiment.

According to one embodiment, in step S810, a platform server (e.g., the platform server 100 in FIG. 1) may receive a request to offer supply product sponsorship. For example, the sponsorship may be for creating content for a supply product. According to one embodiment, the request for the supply product may include information about sponsorship conditions. The sponsorship condition information may include, for example, information on whether a sponsorship product is provided free of charge and information on a numerical value required to distribute sales money.

According to one embodiment, in step S820, the platform server may determine a content creator to receive sponsorship for the supply product. According to one embodiment, the platform server may determine at least one content creator to receive sponsorship for the supply product based on history information about previously created content. For example, the platform server may determine a content creator who has a history of creating content for a product included in the same category as the supply product to be sponsored as at least one content creator to receive sponsorship for the supply product. According to one embodiment, the platform server may determine the ranking of a plurality of content creators. For example, the platform server may determine the ranking of the plurality of content creators determined based on the history information about previously created content. According to one embodiment, the platform server may determine content creators within a specified ranking as the at least one content creator who is to receive sponsorship for the supply product of the supplier.

According to one embodiment, in step S830, the platform server may provide sponsorship condition information to the determined content creator. For example, the sponsorship condition information may be included in the request to offer supply product sponsorship.

According to one embodiment, in step S840, the platform server may request at least one content creator who has accepted the sponsorship conditions to create content for the sponsorship product. According to one embodiment, when the platform server receives a user input accepting the sponsorship conditions, the platform server may request the supplier to sponsor the at least one content creator who has accepted the sponsorship conditions. According to one embodiment, the platform server may request the at least one content creator to create content for the sponsored supply product.

According to one embodiment, in step S850, the platform server may receive the content created in response to the request to create content. According to one embodiment, the platform server may register the received content in a content DB.

According to one embodiment, in step S860, the platform server may provide the registered content to the seller selling the sponsorship product. For example, when the platform server receives a request to provide the content for the supply product, the platform server may upload the content for the supply product to an online shop of a seller who requests the content.

According to one embodiment, in step S870, when the sponsorship product is sold through the online shop, the platform server may distribute a specified proportion of the sales money of the sold product to the content creator. According to one embodiment, the platform server may determine the specified proportion according to a contribution of the at least one content creator to sales of the supply product. According to one embodiment, the platform server may determine the contribution of the content creator based on a difference in sales amounts of the supply product by a plurality of sellers. According to one embodiment, the platform server may determine the contribution of the at least one content creator based on an access route to the online shop where the supply product is sold. For example, when the platform server accesses the online shop where the supply product is sold through the content in a space in which the content creator is identifiable, the platform server may evaluate the contribution of the at least one content creator to be high.

According to one embodiment, steps S810 to S870 may be implemented by a computer program stored in a computer-readable storage medium and configured to be executed by one or more processors. The computer program may include an instruction set implementing steps S810 to S870 in a programming language.

According to various embodiments described with reference to FIGS. 1 to 8, the e-commerce platform service provided through the platform server 100 may allow suppliers, sellers, and content creators for distributing and selling products to gather in one platform service, thereby easily finding experts outside their respective own areas and cooperating with each other to sell products. In addition, the e-commerce platform service can reduce risks that users who cooperate in selling products have to bear when selling products on their own, allow the users to do their best by focusing on their areas of expertise, and further promote product sales by distributing a sales profit according to a proportion of the contribution of the product sales, thereby creating a virtuous cycle structure in which each entity' profit increases and each entity develops in their own area. In addition, this virtuous cycle structure of the e-commerce platform service can form a healthy market that prevents damage to suppliers and sellers due to competition at the lowest price in existing open markets and provides high-quality products to purchasers at reasonable prices.

In addition, the e-commerce platform service of the platform server 100 does not simply provide a space for users to gather, but also uses a content DB registered on a platform to connect users who need content creation to content creators suitable for the content creation through product sponsorship, thereby making it possible to create content with high promotional effectiveness and provide the created content to platform users through various routes, including content sharing services, so that product sales can be promoted. In addition, the e-commerce platform service can evaluate a participant's contribution to product sales using sales information, including a route through which a product whose content is created through sponsorship is sold when the product is sold, and distribute sales money in a certain proportion according to the evaluation, so that even users with small business scale can request the creation of content without burden at a low cost, and even content creators who are not famous can receive an appropriate reward by creating content with product sponsorship. Furthermore, more profits can be shared among participants as the overall sales of the platform and the size of the market itself increase.

What is claimed is:

1. A platform server comprising:
a communication device;
a memory configured to store one or more instructions; and
a processor configured to execute the one or more instructions stored in the memory,
wherein the processor executes the one or more instructions to:
register suppliers' supply products to be sold in an e-commerce platform service in a supply product database (DB);
register a plurality of sellers with a hierarchy including an upper seller and at least one sub seller subordinate to the upper seller in a seller DB, the sub seller being subordinate to a top seller in the hierarchy among upper sellers to whom sale products and sales conditions of the products are subordinate;
register at least one sale product of the top seller in a sale product DB, the at least one sale product being at least one of the supply products registered in the supply product DB;
create an online shop for each of the plurality of sellers, the online shop including at least one of registered sale products of a top seller to whom each of the plurality of sellers is subordinate;
register a plurality of content creators in a content creator DB;
register content created by the plurality of content creators in a content DB;
determine at least one content creator to receive sponsorship for a supply product from a supplier registered in the supply product DB among the plurality of content creators registered in the content creator DB based on history information about content previously, the previously created content being content registered in the content DB;
provide content for the supply product that is created by the at least one content creator to at least one seller registered in the seller DB selling the supply product; and
distribute a specified proportion of sales money of the sold product to the at least one content creator when the supply product is sold through the online shop of the at least one seller.

2. The platform server of claim 1, wherein the processor executes the one or more instructions to determine a content creator who has a history of creating content for a product included in the same category as the supply product to be sponsored as at least one content creator to receive sponsorship for the supply product.

3. The platform server of claim 1, wherein the processor executes the one or more instructions to:
determine ranking of the plurality of content creators; and
determine a content creator within a specified ranking as at least one content creator to receive sponsorship for the supply product.

4. The platform server of claim 3, wherein the processor executes the one or more instructions to determine the ranking of the plurality of content creators based on at least one of the number of times previously created content is used in the online shop of the seller and a sales amount of the used product.

5. The platform server of claim 3, wherein the processor executes the one or more instructions so that new content creators creating a specified number of content items or less are included in the specified ranking in a specified proportion among the plurality of content creators.

6. The platform server of claim 1, wherein the processor executes the one or more instructions to:
receive sponsorship condition information for the supply product from the supplier terminal;
provide the sponsorship condition information to the at least one content creator;
request the supplier to sponsor the supply product to the at least one content creator upon receiving a user input accepting a sponsorship condition from a content creator terminal;
request the at least one content creator to create content for the supply product for sponsorship; and
provide, to the at least one seller, content for the sponsored supply product that is created in response to the request to create content.

7. The platform server of claim 6, wherein the content created in response to the request to create content is received from the content creator terminal,
the received content is registered in the content DB, and
the registered content is uploaded to a sales page of the online shop of the at least one seller upon receiving a request to provide the registered content from a seller terminal.

8. The platform server of claim 6, wherein the sponsorship condition information includes information on whether the sponsorship product is provided free of charge and information on a numerical value required to distribute sales money.

9. The platform server of claim 1, wherein the processor executes the one or more instructions to determine the specified proportion according to a contribution of the at least one content creator to sales of the supply product.

10. The platform server of claim 9, wherein the processor executes the one or more instructions to determine the contribution of the at least one content creator based on sales amounts of the plurality of sub sellers selling the supply products.

11. The platform server of claim 9, wherein the processor executes the one or more instructions to determine the contribution of the at least one content creator based on an access route to the online shop where the supply product is sold.

12. The platform server of claim 11, wherein the created content is provided to a purchaser through a space in which the at least one content creator is identifiable, and
a specified weight is assigned to the contribution of the at least one content creator when the purchaser accesses the online shop where the supply product is sold through the content for the space.

13. The platform server of claim 1, wherein the processor executes the one or more instructions to upload the registered content to the online shop of the at least one seller upon receiving a request to provide the registered content from a seller terminal.

14. The platform server of claim 13, wherein the processor executes the one or more instructions to:
determine the specified proportion according to a contribution of the at least one content creator to sales of the supply product; and
determine the contribution of the at least one content creator based on a sales amount of the sub seller in the hierarchy.

15. A method of operating a server that provides an e-commerce platform service, the method comprising:
registering suppliers' supply products to be sold in an e-commerce platform service in a supply product database (DB);
registering a plurality of sellers with a hierarchy including an upper seller and at least one sub seller subordinate to the upper seller in a seller DB, the sub seller being subordinate to a top seller in the hierarchy among upper sellers to whom sale products and sales conditions of the products are subordinate;
registering at least one sale product of the top seller in a sale product DB, the at least one sale product being at least one of the supply products registered in the supply product DB;
creating an online shop for each of the plurality of sellers, the online shop including at least one of registered sale products of a top seller to whom each of the plurality of sellers is subordinate;
registering a plurality of content creators in a content creator DB;
registering content created by the plurality of content creators in a content DB;
determining at least one content creator to receive sponsorship for a supply product from a supplier registered in the supply product DB among the plurality of content creators registered in the content creator DB based on history information about content previously, the previously created content being content registered in the content DB;
providing content for the supply product that is created by the at least one content creator to at least one seller registered in the seller DB selling the supply product; and
distributing a specified proportion of sales money of the sold product to the at least one content creator when the supply product is sold through the online shop of the at least one seller.

16. A computer program stored in a computer-readable storage medium and configured to be executed by one or more processors, the computer program comprising:
an instruction to register suppliers' supply products to be sold in an e-commerce platform service in a supply product database (DB);
an instruction to register a plurality of sellers with a hierarchy including an upper seller and at least one sub seller subordinate to the upper seller in a seller DB, the sub seller being subordinate to a top seller in the hierarchy among upper sellers to whom sale products and sales conditions of the products are subordinate;
an instruction to register at least one sale product of the top seller in a sale product DB, the at least one sale product being at least one of the supply products registered in the supply product DB;
an instruction to create an online shop for each of the plurality of sellers, the online shop including at least one of registered sale products of a top seller to whom each of the plurality of sellers is subordinate;
an instruction to register a plurality of content creators in a content creator DB;
an instruction to register content created by the plurality of content creators in a content DB;
an instruction to determine at least one content creator to receive sponsorship for a supply product from a supplier registered in the supply product DB among the plurality of content creators registered in the content creator DB based on history information about content previously, the previously created content being content registered in the content DB;
an instruction to provide content for the supply product that is created by the at least one content creator to at least one seller registered in the seller DB selling the supply product; and
an instruction to distribute a specified proportion of sales money of the sold product to the at least one content creator when the supply product is sold through the online shop of the at least one seller.
